(19) United States
(12) Patent Application Publication
(10) Pub. No.: US 2026/0129401 A1
(43) Pub. Date: May 7, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventor: YUJI TSUCHIDA, TOKYO (JP)

(21) Appl. No.: 19/117,495

(22) PCT Filed: Sep. 21, 2023
(86) PCT No.: PCT/JP2023/034201

§ 371 Date: Apr. 1, 2025

(30) Foreign Application Priority Data
Oct. 7, 2022 (JP) 2022-162112

(51) Int. Cl. H04S 7/00; G06F 3/16

(52) U.S. Cl. CPC H04S 7/306; G06F 3/165; H04S 2400/13

(57) ABSTRACT

The present disclosure relates to an information processing device, an information processing method, and a program that can make impulse response adjustment work efficient.

A level control unit changes a level of a first sound component and a level of a second sound component in response to adjustment of a parameter correlated with the first sound component and the second sound component included in an impulse response. The technique according to the present disclosure can be applied to, for example, a remote ensemble system.

### TECHNICAL FIELD

The present disclosure relates to an information processing device, an information processing method, and a program, and more particularly relates to an information processing device, an information processing method, and a program that can make impulse response adjustment work efficient.

### BACKGROUND ART

There is known a remote ensemble system that enables a plurality of players to perform an ensemble in a state where the plurality of players are at respectively remote places.

For example, Patent Literature 1 discloses a remote ensemble system that enables a high-level ensemble of a plurality of players at remote places by convoluting for an acoustic signal of a plurality of co-performing users a head-related transfer function matching a positional relationship between users in a virtual space.

There is a case where, in such a remote ensemble system, players (users) listen to an acoustic signal obtained by convoluting an impulse response of sound field reproduction into a microphone (mic) input.

### CITATION LIST

### Patent Literature

PTL 1
WO 2022/196073

### SUMMARY

### Technical Problem

When a user adjusts transfer characteristics from a sound source to both ears of the user, for example, an absolute sound volume is characteristics that change as the impulse response is adjusted, and therefore it has been necessary to repeat fine adjustment until these adjustment items converge to optimal values.

With such a situation in view, the present disclosure can make impulse response efficient adjustment efficient.

### Solution to Problem

An information processing device according to the present disclosure is an information processing device that includes a level control unit that changes a level of a first sound component and a level of a second sound component in response to adjustment of a parameter correlated with the first sound component and the second sound component included in an impulse response.

An information processing method according to the present disclosure is an information processing method that includes, at an information processing device, changing a level of a first sound component and a level of a second sound component in response to adjustment of a parameter correlated with the first sound component and the second sound component included in an impulse response.

A program according to the present disclosure is a program that causes a computer to execute processing of changing a level of a first sound component and a level of a second sound component in response to adjustment of a parameter correlated with the first sound component and the second sound component included in an impulse response.

According to the present disclosure, a level of a first sound component and a level of a second sound component are changed in response to adjustment of a parameter correlated with the first sound component and the second sound component included in an impulse response.

### BRIEF DESCRIPTION OF DRAWINGS

FIG. 1 is a diagram illustrating a configuration example of a remote ensemble system according to an embodiment of the present technique.

FIG. 2 is a diagram illustrating an example of devices provided in a booth.

FIG. 3 is a diagram illustrating an example of a sound component of an impulse response.

FIG. 4 is a diagram illustrating an example of a UI for adjustment of a conventionally assumable impulse response.

FIG. 5 is a diagram illustrating an example of a UI for adjustment of an impulse response according to the present disclosure.

FIG. 6 is a diagram illustrating an example of the UI for adjustment of the UI for adjustment of an impulse response impulse response according to the present disclosure.

FIG. 7 is a diagram illustrating an example of the UI for adjustment of the impulse response according to the present disclosure.

FIG. 8 is a block diagram illustrating a functional configuration example of an information processing device.

FIG. 9 is a flowchart for explaining a flow of impulse response adjustment processing.

FIG. 10 is a flowchart for explaining a flow of level control matching an adjustment item.

FIG. 11 is a flowchart for explaining a flow of level control matching the adjustment item.

FIG. 12 is a block diagram illustrating a configuration example of hardware of a computer.

### DESCRIPTION OF EMBODIMENTS

Hereinafter, modes for carrying out the present disclosure (hereinafter referred to as embodiments) will be described. Note that the description will be presented in the following order.
1. Configuration and problem of remote ensemble system
2. Example of UI for adjustment of impulse response
3. Configuration of information processing device and impulse response adjustment processing
4. Application examples
5. Configuration example of computer

### 1. Configuration and Problem of Remote Ensemble System

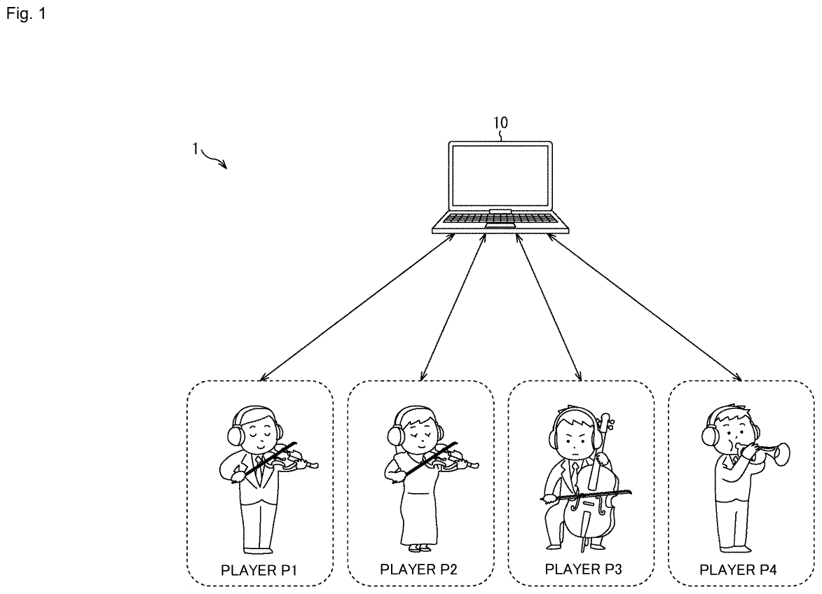

FIG. 1 is a diagram illustrating a configuration example of a remote ensemble system according to an embodiment of the present technique.

A remote ensemble system 1 illustrated in FIG. 1 is a system used for a so-called remote ensemble performed by players at remote places.

The example in FIG. 1 illustrates players P1 to P4 who are orchestra players. Musical instruments that the player P1 and the player P2 play are violins, and a musical instrument that the player P3 plays is a cello. A musical instrument that the player P4 plays is a trumpet.

Note that the number of players is not limited to four, and a remote ensemble is actually performed by more players using more types of musical instruments. The number of players varies depending on band formations.

The remote ensemble system 1 in FIG. 1 is configured by connecting to a transmission control device 10 a plurality of information processing devices used by the players P1 to P4. The transmission control device 10 and each information processing device may be connected by wired communication, or may be connected by wireless communication. In a case where the transmission control device 10 and the plurality of information processing devices used by the players P1 to P4 are connected by wired communication, predetermined standards such as a Universal Serial Bus (USB) cable may be used. Furthermore, in a case where the transmission control device 10 and the plurality of information processing devices used by the players P1 to P4 are connected by wireless communication, an arbitrary communication protocol such as Wi-Fi (registered trademark) or Bluetooth (registered trademark) may be used.

The players P1 to P4 perform in remote spaces. For example, different booths prepared in a studio are used as spaces for performance. In FIG. 1, broken-line rectangles surrounding the players P1 to P4 indicate that the players P1 to P4 are performing in the respectively different booths.

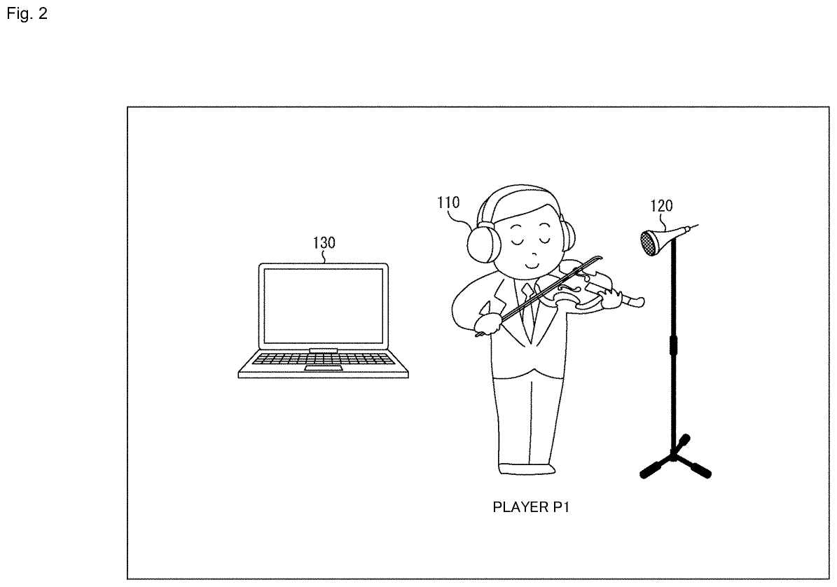

FIG. 2 is a diagram illustrating an example of devices provided in the booth.

As illustrated in FIG. 2, the booth of the player P1 is provided with a headphone 110, a microphone (mic) 120, and an information processing device 130. The headphone 110 and the mic 120 are connected to the information processing device 130 configured as a Personal Computer (PC), smartphone, a tablet terminal, or the like. The mic 120 may be directly connected to the transmission control device 10 as appropriate. The headphone 110, the mic 120, and the information processing device 130 may be each connected by wire or wirelessly.

The headphone 110 is an output device equipped by the head of the player P1. The headphone 110 outputs a played sound of the player P1 and played sounds of co-players under control of the information processing device 130. Earphones (inner ear headphones) may be used as output devices instead of the headphones.

The mic 120 collects a played sound of the player P1 (a sound from the musical instrument played by the player P1).

The booths of the players P2 to P4 are each provided with three devices of the headphone 110, the mic 120, and the information processing device 130 similarly to the booth of the player P1.

As described above, in the remote ensemble system 1, each player is equipped with the headphone 110, and performs facing the mic 120 while listening to played sounds output from the headphone 110.

This remote ensemble system 1 enables the players to immerse in own performance by virtually reproducing an actual performance environment. For this virtual reproduction, it is necessary to accurately reproduce not only an impulse response of a sound field, but also an absolute sound volume unlike sound field reproduction of conventional appreciation of content such as movies and music.

Furthermore, at a time of performance during sound field reproduction, a distance between the mic 120 that collects a sound from a musical instrument and the headphone 110 equipped by the head of a player becomes close. Here, in a case where an open-type headphone is used as the headphone 110, howling or the like may occur due to acoustic feedback between the headphone 110 and the mic 120. To avoid this problem, in a case where a closed-type headphone or earphones is used, a player cannot directly listen to a sound from an own musical instrument, and therefore listens, via the headphone, to an acoustic signal obtained by convoluting into a mic input an impulse response of sound field reproduction including a direct sound.

However, as for a transfer function (transfer characteristics) from a musical instrument that is a sound source to both ears of a player, it is known that, for example,
A propagation distance is very short, and a musical instrument itself has a complicated radiation pattern
A component transmitting through bone conduction or the like also influences an auditory sense.

In view of these, the transfer function obtained by measurement or calculation performed in advance has made players subjectively have a sense of discomfort.

Furthermore, reproduction of the absolute sound volume requires calibration of sensitivity in an individual playback environment, and has been realistically difficult in many cases.

In view of the above, it has been necessary for the players to finely adjust.
the “absolute sound volume”
“a level of a direct sound from an own musical instrument” (hereinafter, referred to simply as “the level of the direct sound”)
“a level of an indirect sound from the own musical instrument” (hereinafter, referred to simply as “the level of the indirect sound”)
before playing performance.

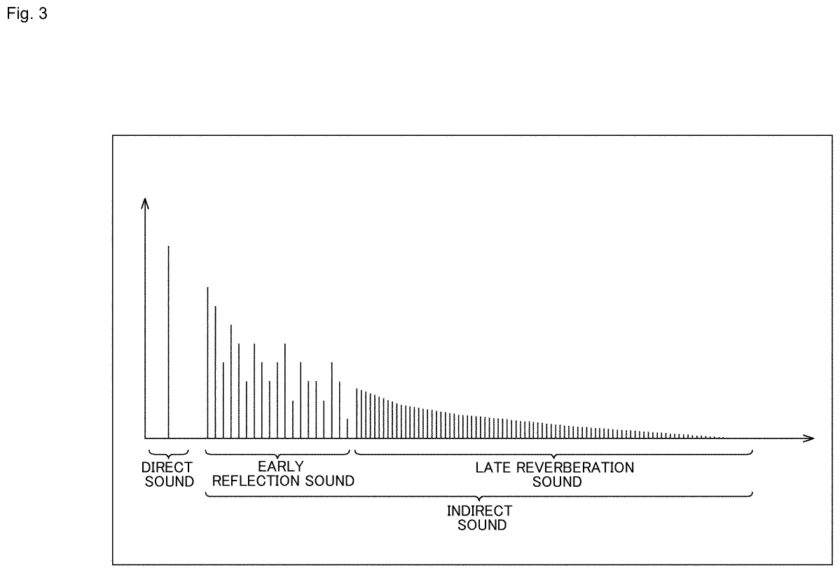

FIG. 3 is a diagram illustrating an example of a sound component of an impulse response for a playback sound collected by the mic 120 from a musical instrument played by a player, and played back by the headphone 110 equipped by the head of the player.

As illustrated in FIG. 3, a sound component of an impulse response can be roughly classified into the “direct sound” and the “indirect sound”. Furthermore, the “indirect sound” can be classified into an “early reflection sound” and a “late reverberation sound”. When finely adjusting the impulse response, a player adjusts a level of each of these adjustment items (parameters).

On the other hand, the “absolute sound volume” is determined according to a sum of “energy of a direct sound” and “energy of an indirect sound”, and therefore “the level of the direct sound” as the adjustment item is not completely independent from the “absolute sound volume”. Hence, in a case where “the level of the direct sound” is adjusted, readjustment of the “absolute sound volume” has become necessary, and, by contrast with this, in a case where the “absolute sound volume” is adjusted, readjustment of “the level of the direct sound” has become necessary.

Due to such correlation between these adjustment items (parameters), players have needed to repeat fine adjustment until all of these adjustment items converge to optimal values.

Here, “the level of the direct sound” takes, for example, a value of the amplitude of the direct sound, and “the energy of the direct sound” takes, for example, a value obtained by cumulatively adding squares of sample values of impulse responses used for signal processing over a time section of the direct sound. “The level of the indirect sound” and “the energy of the indirect sound” may be defined similarly to the direct sound. Furthermore, “a ratio of the direct sound and the indirect sound” to be described later is, for example, a ratio of the energy of the direct sound and the energy of the indirect sound. The “level” and the “energy” of each of the direct sound and the indirect sound are not limited to these, and may be defined on the basis of other physical amounts related to each sound.

### 2. Example of Ui for Adjustment of Impulse Response

Hereinafter, an example of a User Interface (UI) for adjustment of the above-described impulse response will be described.

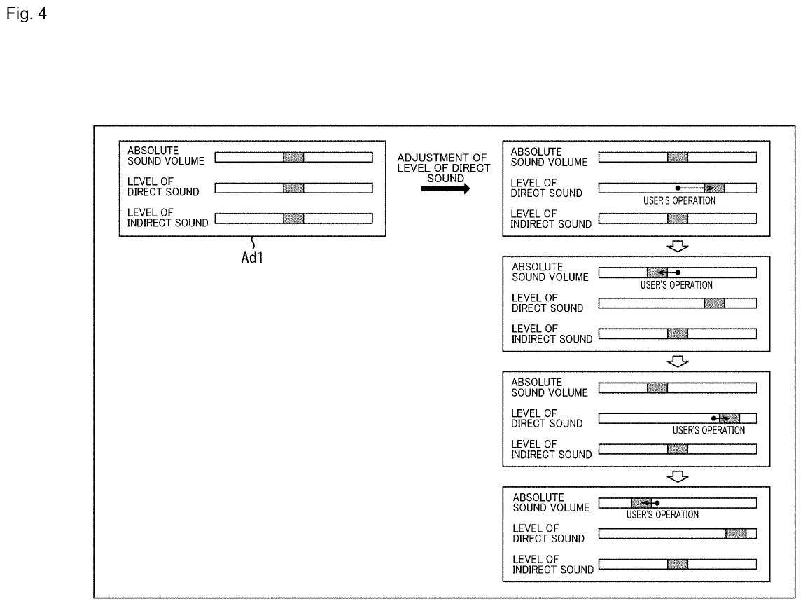

FIG. 4 is a diagram illustrating an example of a UI for adjustment of a conventionally assumable impulse response.

FIG. 4 illustrates an adjustment screen Ad1 presented as the UI for adjustment of the impulse response.

The adjustment screen Ad1 is provided with sliders that indicate respective values of the “absolute sound volume”, “the level of the direct sound”, and “the level of the indirect sound” that are the adjustment items (parameters), and accept adjustment of these parameters.

FIG. 4 illustrates the example of a process of adjustment work in a case where the level of the direct sound is adjusted in the adjustment screen Ad1. More specifically, “the level of the direct sound” is adjusted by a user's (player's) operation. In this case, the “absolute sound volume” correlated with the level of the direct sound changes, and therefore the “absolute sound volume” is adjusted by the user's operation. Then, “the level of the direct sound” changes, and therefore “the level of the direct sound” is adjusted again by a user's operation. In this case, the “absolute sound volume” changes again, and therefore the “absolute sound volume” is adjusted again by a user's operation.

As described above, the “absolute sound volume” and “the level of the direct sound” are not independent from each other, and therefore, until each of the “absolute sound volume” and “the level of the direct sound” converges to an optimal value, it has been necessary for a user to alternately finely adjust the “absolute sound volume” and “the level of the direct sound”.

By contrast with this, the technique according to the present disclosure converts and aggregates adjustment items (parameters) based on following two viewpoints to make impulse response adjustment work efficient.

### (1) Subjective Easiness of Adjustment for Player

The adjustment items such as the “the level of the direct sound” and “the level of the indirect sound” are classifications for ease of description in a case where impulse responses are synthesized, and are not directly associated with a sound that a player (user) finally listens to. That is, the player cannot separate and listen to only the “direct sound” from sounds finally output from a headphone, and cannot separate and listen to only the “indirect sound”.

This is a factor that a player has difficulty in subjectively understanding how an adjustment operation has been reflected in an adjustment result even when the player performs the adjustment operation based on classifications such as the “direct sound” and the “indirect sound”.

By contrast with this, the adjustment items (parameters) are converted into “items that allow a player to subjectively easily grasp how the adjustment operation has been reflected in the adjustment result” to make the impulse response adjustment work efficient.

### (2) Reduction of Extra Dimensions of Adjustment Items

The “absolute sound volume”, “the level of the direct sound”, and the “level of the indirect sound” that are the adjustment items are not independent from each other, and therefore dimensionality of the parameters becomes excessive. As the number of adjustment items becomes larger, adjustment work becomes more complicated.

Hence, extra dimensions of adjustment items are reduced and the number of adjustment items is reduced to make the impulse response adjustment work efficient.

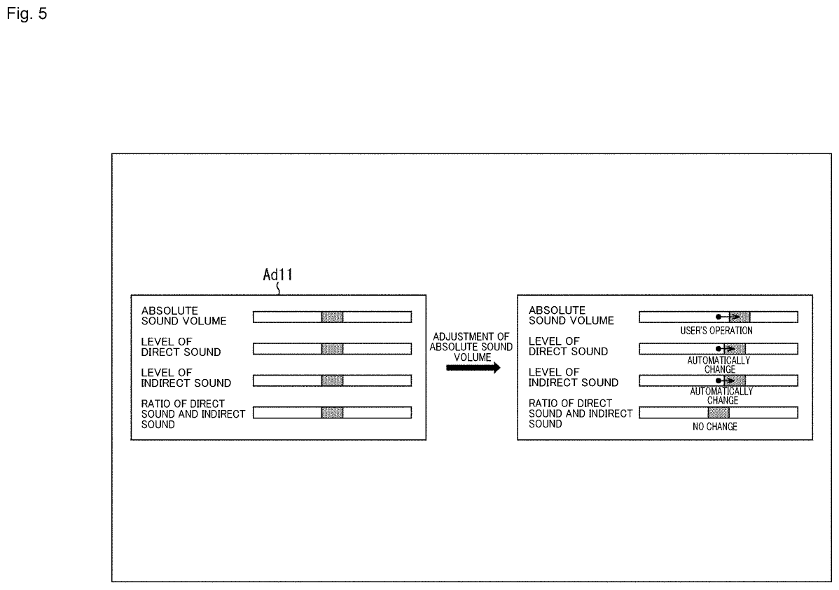

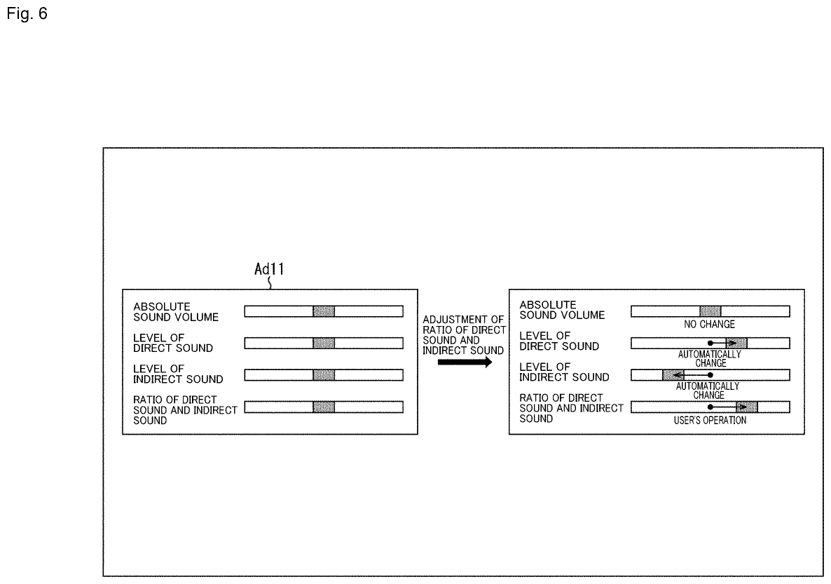

FIGS. 5 and 6 are diagrams illustrating examples of a UI for adjustment of an impulse response according to the present disclosure.

FIGS. 5 and 6 illustrate an adjustment screen Ad11 presented as a UI for adjustment of an impulse response.

In addition to a configuration similar to that of the adjustment screen Ad1 in FIG. 4, the adjustment screen Ad11 is provided with a slider that indicates a value of “the ratio of the direct sound and the indirect sound” that is the adjustment item (parameter), and accepts adjustment of the parameter. Note that, as a UI used for adjustment of the parameter, a UI (e.g., a radio button or an audio input) other than the slider may be used.

FIG. 5 illustrates the example of a process of adjustment work in a case where the absolute sound volume is adjusted in the adjustment screen Ad11. More specifically, when the “absolute sound volume” is adjusted by a user's (player's) operation, “the level of the direct sound” and “the level of the indirect sound” automatically change based on a relational expression expressing each of “the level of the direct sound” and “the level of the direct sound” using the “absolute sound volume”. In this case, “the ratio of the direct sound and the indirect sound” does not change, and is kept constantly.

Furthermore, FIG. 6 illustrates the example of a process of adjustment work in a case where the ratio of the direct sound and the indirect sound is adjusted in the adjustment screen Ad11. More specifically, when “the ratio of the direct sound and the indirect sound” is adjusted by a user's (player's) operation, “the level of the direct sound” and “the level of the indirect sound” automatically change based on a relational expression expressing each of “the level of the direct sound” and “the level of the direct sound” using “the ratio of the direct sound and the indirect sound”. In this case, the “absolute sound volume” does not change, and is kept constantly.

As described, by adjusting “the absolute volume” and “the ratio of the direct sound and the indirect sound” that allow the user to subjectively easily grasp how an adjustment operation has been reflected in an adjustment result in the adjustment screen Ad11, “the level of the direct sound” and “the level of the indirect sound” are automatically adjusted.

Note that the adjustment screen Ad11 may be provided with indicators that only indicate respective values of “the level of the direct sound” and “the level of the indirect sound” in response to adjustment of the “absolute sound volume” and “the ratio of the direct sound and the indirect sound” instead of the respective sliders of “the level of the direct sound” and “the level of the indirect sound”. In this case, these indicators are configured to not accept adjustment of “the level of the direct sound” and “the level of the indirect sound”.

Here, when “the level of the direct sound” or “the level of the indirect sound” is adjusted, this adjustment may not be accepted by fixing a value designated by the user among the “absolute sound volume” and “the ratio of the direct sound and the indirect sound”, or an unfixed value may be automatically changed. When, for example, “the level of the direct sound” is changed in a state where the “absolute sound volume” is fixed, “the level of the indirect sound” and “the ratio of the direct sound and the indirect sound” are automatically adjusted without changing the absolute sound volume (i.e., a sum of the level of the direct sound and the level of the indirect sound”). Note that a parameter to be fixed may be arbitrarily designated by the user as described above, or may be determined on the basis of environment information (e.g., the size or a material of a performance environment) or the like at a time when an impulse response is measured or may be determined by a method other than the above-described method.

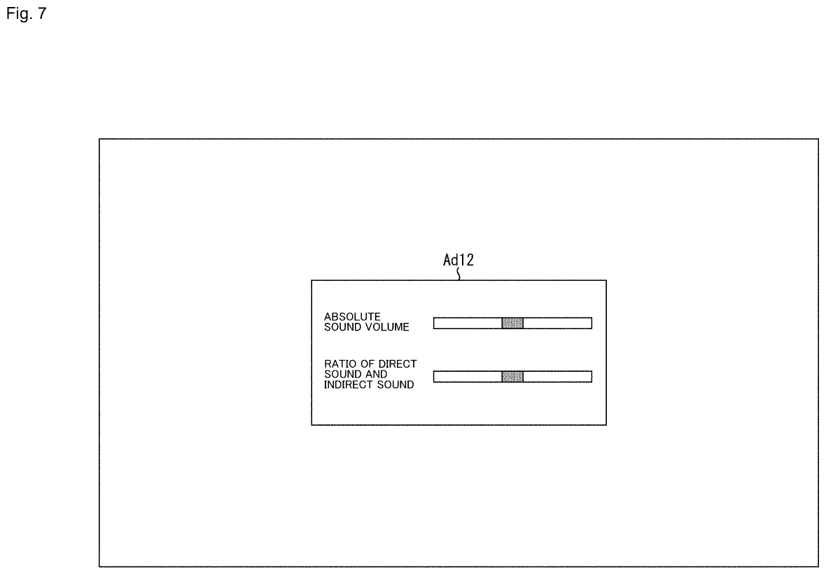

Furthermore, only sliders for adjusting each of the “absolute sound volume” and “the ratio of the direct sound and the indirect sound” may be presented as in an adjustment screen Ad12 illustrated in FIG. 7 without presenting the sliders or the indicators of “the level of the direct sound” and “the level of the indirect sound”. Note that the user may appropriately set what item to present on the adjustment screen among the “absolute sound volume”, “the level of the direct sound”, “the level of the indirect sound”, and “the ratio of the direct sound and the indirect sound” that are items to be presented on the adjustment screen. Furthermore, although the afore-mentioned four parameters have been cited as the examples of the items to be presented on the adjustment screen, it may be possible to additionally add and present parameters other than these parameters.

### 3. Configuration of Information Processing Device and Impulse Response Adjustment Processing

Hereinafter, a configuration of the information processing device to which the technique according to the present disclosure has been applied, and the impulse response adjustment processing of the information processing device will be described.

### (Configuration of Information Processing Device)

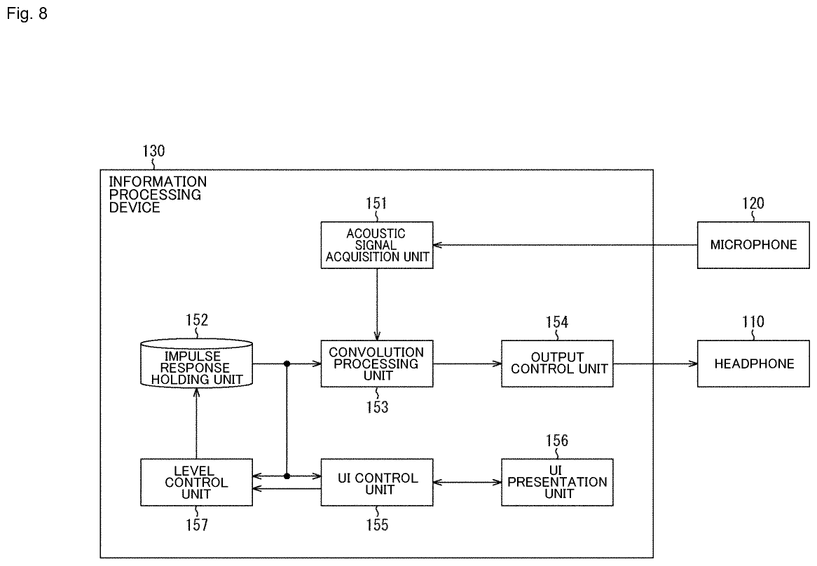

FIG. 8 is a block diagram illustrating a functional configuration example of the information processing device 130 to which the technique according to the present disclosure has been applied. At least part of the functional blocks illustrated in FIG. 8 are implemented by executing a program by a Central Processing Unit (CPU) mounted on a PC or the like that configures the information processing device 130.

The information processing device 130 illustrated in FIG. 8 includes an acoustic signal acquisition unit 151, an impulse response holding unit 152, a convolution processing unit 153, an output control unit 154, a UI control unit 155, a UI presentation unit 156, and a level control unit 157.

The acoustic signal acquisition unit 151 acquires an acoustic signal of a played sound collected by the mic 120. The acoustic signal acquired by the acoustic signal acquisition unit 151 is supplied to the convolution processing unit 153.

The impulse response holding unit 152 holds an impulse response of sound field reproduction measured or calculated in advance in a performance environment in which the user (player) plays a musical instrument. The impulse response held in the impulse response holding unit 152 is acquired by the convolution processing unit 153, the UI control unit 155, and the level control unit 157 as needed. In addition to the measured impulse response, the impulse response holding unit 152 may hold (store) environment information (e.g., the type, the size (such as the volume), and the shape of a performance environment such as a concert hall or a stadium, and a material to be used for a wall surface or a floor surface of the performance environment) at a time when the impulse response is measured.

The convolution processing unit 153 executes convolution processing of convoluting the impulse response acquired from the impulse response holding unit 152 into the acoustic signal supplied from the acoustic signal acquisition unit 151. The acoustic signal subjected to the convolution processing is supplied to the output control unit 154.

The output control unit 154 causes the headphone 110 to output a playback sound that is based on the acoustic signal supplied from the convolution processing unit 153.

The UI control unit 155 controls presentation of the UI (adjustment screen) for adjustment of the impulse response described with reference to FIGS. 5 and 6 by controlling the UI presentation unit 156. More specifically, the UI control unit 155 controls presentation of a UI that indicates a value of a parameter (adjustment item) correlated with a sound component included in the impulse response held in the impulse response holding unit 152, and includes a GUI part (e.g., a slider or a button) that accepts adjustment of the parameter. Furthermore, the UI is not limited to the afore-mentioned slider or the like, and a UI such as a knob, a button, and a voice may be used.

Furthermore, the UI control unit 155 supplies to the level control unit 157 a setting value of each adjustment item set in the UI presented by the UI presentation unit 156, and operation information indicating a user's operation on the UI.

The UI presentation unit 156 includes a display unit such as a liquid crystal display, a Light Emitting Diode (LED) display, or an Electro-Luminescence (EL) display that can display a UI, and an operation unit such as a keyboard or a mouse that can accept the user's operation. The UI presentation unit 156 may include a touch panel monitor that has respective functions of the display unit and the operation unit. The UI presentation unit 156 may be configured integrally with the information processing device 130 that is configured as the PC or the like, or may be configured separately from the information processing device 130.

The level control unit 157 changes the levels of the first sound component and the second sound component included in the impulse response held in the impulse response holding unit 152 in response to the user's operation indicated by the operation information from the UI control unit 155. The user's operation indicated by the operation information from the UI control unit 155 is, for example, an operation for adjustment of a parameter correlated with the first sound component and the second sound component included in the impulse response.

More specifically, the level control unit 157 changes the level of the first sound component and the level of the second sound component based on a relational expression expressing each of the level of the first sound component and the level of the second sound component using the parameter adjusted in response to the user's operation. Note that the following description will be given assuming that the first sound component included in the impulse response is a “direct sound”, and the second sound component is an “indirect sound”.

### (Impulse Response Adjustment Processing)

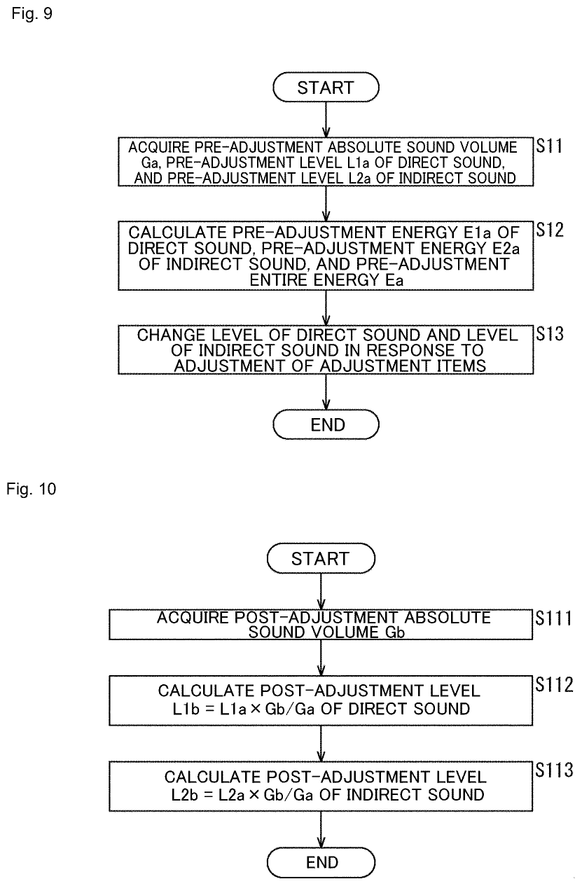

A flow of the impulse response adjustment processing executed by the level control unit 157 of the information processing device 130 in FIG. 8 will be described with reference to a flowchart illustrated in FIG. 9.

In step S11, the level control unit 157 acquires via the UI control unit 155 setting values of a pre-adjustment absolute sound volume Ga, a pre-adjustment level L1a of the direct sound, and a pre-adjustment level L2a of the indirect sound set in the UI presented by the UI presentation unit 156.

In step S12, the level control unit 157 calculates pre-adjustment energy Ela of the direct sound, pre-adjustment energy E2a of the indirect sound, and pre-adjustment entire energy Ea based on a pre-adjustment impulse response supplied to the convolution processing unit 153.

Each of the energy Ela of the direct sound and the energy E2a of the indirect sound is obtained by cumulatively adding squares of sample values of each of the level L1a of the direct sound and the level L2a of the indirect sound. Furthermore, the entire energy Ea is obtained as a sum of the energy Ela of the direct sound and the energy E2a of the indirect sound.

In step S13, the level control unit 157 changes the level of the direct sound and the level of the indirect sound of the impulse response held in the impulse response holding unit 152 in response to adjustment of adjustment items in the UI presented by the UI presentation unit 156.

Here, one of the “absolute sound volume” and “the ratio of the direct sound and the indirect sound” are adjusted as the adjustment items in the UI.

(a) Level Control of Direct Sound and Indirect Sound in Case where Absolute Sound Volume is Adjusted

First, a flow of level control of the direct sound and the indirect sound in a case where the “absolute sound volume” is adjusted as the adjustment item in step S13 in FIG. 9 will be described with reference to a flowchart in FIG. 10.

In step S111, the level control unit 157 acquires via the UI control unit 155 a setting value of a post-adjustment absolute sound volume Gb in the UI presented by the UI presentation unit 156.

In step S112, the level control unit 157 calculates a post-adjustment level L1b of the direct sound indicated using the post-adjustment absolute sound volume Gb. The post-adjustment level Lib of the direct sound is expressed by a following relational expression using the post-adjustment absolute sound volume Gb, the pre-adjustment absolute sound volume Ga, and the pre-adjustment level L1a of the direct sound.

$$[ Math . 1 ]$$

$$L 1 b = L 1 a \times Gb / Ga \qquad ( 1 )$$

In step S113, the level control unit 157 calculates a post-adjustment level L2b of the indirect sound indicated using the post-adjustment absolute sound volume Gb. The post-adjustment level L2b of the indirect sound is expressed by a following relational expression using the post-adjustment absolute sound volume Gb, the pre-adjustment absolute sound volume Ga, and the pre-adjustment level L2a of the indirect sound.

$$[ Math . 2 ]$$

$$L 2 b = L 2 a \times Gb / Ga \qquad ( 2 )$$

As described above, when the absolute sound volume is adjusted, the level control unit 157 changes each of “the level of the direct sound” and “the level of the indirect sound” according to a change rate (Gb/Ga) of the absolute sound volume. That is, the post-adjustment level Lib of the direct sound and the post-adjustment level L2b of the indirect sound may be updated according to a ratio of the pre-adjustment absolute sound volume Ga and the post-adjustment absolute sound volume Gb.

(b) Level Control of Direct Sound and Indirect Sound in Case where Ratio of Direct Sound and Indirect Sound is Adjusted

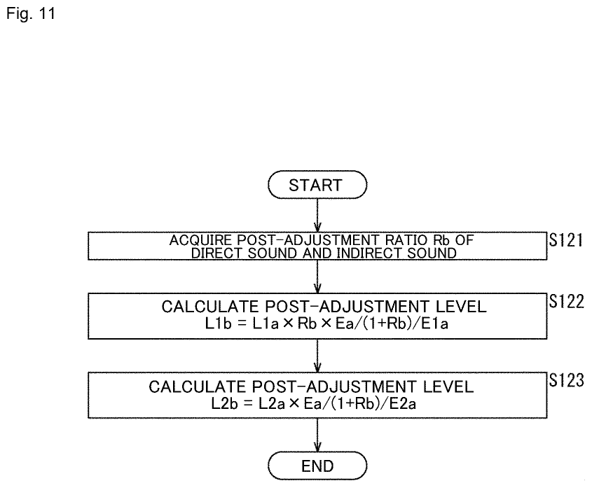

Next, a flow of level control of the direct sound and the indirect sound in a case where “the ratio of the direct sound and the indirect sound” is adjusted as the adjustment item in step S13 in FIG. 9 will be described with reference to a flowchart in FIG. 11.

In step S121, the level control unit 157 acquires via the UI control unit 155 a setting value of a post-adjustment ratio Rb of the direct sound and the indirect sound in the UI presented by the UI presentation unit 156.

In step S122, the level control unit 157 calculates the post-adjustment level Lib of the direct sound indicated using the post-adjustment ratio Rb of the direct sound and the indirect sound.

In step S123, the level control unit 157 calculates the post-adjustment level L2b of the indirect sound indicated using the post-adjustment ratio Rb of the direct sound and the indirect sound.

Hereinafter, deriving a relational expression expressing each of the post-adjustment level L1b of the direct sound and the post-adjustment level L2b of the indirect sound using the post-adjustment ratio Rb of the direct sound and the indirect sound will be described.

First, the pre-adjustment energy Ela of the pre-adjustment direct sound, the pre-adjustment energy E2a of the indirect sound, and the pre-adjustment entire energy Ea is expressed by a following relational expression.

$$[ Math . 3 ]$$

$$Ea = E 1 a + E 2 a \qquad ( 3 )$$

On the other hand, since a ratio of the post-adjustment energy E1b of the direct sound and the post-adjustment energy E2b of the indirect sound is identical to the post-adjustment ratio Rb of the direct sound and the indirect sound that is an adjustment target, a following equation holds.

$$[ Math . 4 ]$$

$$Rb = E 1 b / E 2 b \qquad ( 4 )$$

Furthermore, as a restriction condition for restricting the entire energy (absolute sound volume) from changing before and after adjustment of the ratio of the direct sound and the indirect sound, a following equation holds.

$$[ Math . 5 ]$$

$$Ea = E 1 b + E 2 b \qquad ( 5 )$$

By substituting equation (5) into equation (4), the following equation can be obtained.

$$[ Math . 6 ]$$

$$Rb = E 1 b / ( Ea - E 1 b ) \qquad ( 6 )$$

Furthermore, equation (6) is deformed as follows for post-adjustment energy E1b of the direct sound.

$$[ Math . 7 ]$$

$$\begin{matrix}E 1 b = Rb \times ( Ea - E 1 b ) = Rb \times Ea - Rb \times E 1 b \\ E 1 b + Rb \times E 1 b = Rb \times Ea \\ E 1 b ( 1 + Rb ) = Rb \times Ea \\ E 1 b = Rb \times Ea / ( 1 + Rb )\end{matrix} \qquad ( 7 )$$

By substituting equation (7) into equation (4), a following equation can be obtained for post-adjustment energy E2b of the indirect sound.

$$[ Math . 8 ]$$

$$\begin{matrix}E 2 b = E 1 b / Rb \\ = \{ Rb \times Ea / ( 1 + Rb ) \} / Rb \\ = Ea / ( 1 + Rb )\end{matrix} \qquad ( 8 )$$

A control target value of the ratio of each energy of the direct sound and the indirect sound can be obtained as follows from the post-adjustment ratio Rb of the direct sound and the indirect sound using above-described equation (7) and equation (8).

That is, since a change amount of the level of the direct sound before and after adjustment, and the change amount of the energy of the direct sound before and after adjustment have a proportional relationship, a following relational expression holds.

$$[ Math . 9 ]$$

$$E 1 b = E 1 a \times L 1 b / L 1 a \qquad ( 9 )$$

By substituting equation (9) into equation (7), a following equation can be obtained for the post-adjustment level L1b of the direct sound.

$$[ Math . 10 ]$$

$$\begin{matrix}E 1 a \times L 1 b / L 1 a = \\ L 1 b = L 1 a \times Rb \times Ea / ( 1 + Rb ) / E 1 a\end{matrix} \qquad ( 10 )$$

Similarly, since the change amount of the level of the indirect sound before and after adjustment, and the change amount of the energy of the indirect sound before and after adjustment have a proportional relationship, a following relational expression holds.

$$[ Math . 11 ]$$

$$E 2 a \times L 2 b / L 2 a \qquad ( 11 )$$

By substituting equation (11) into equation (8), a following equation can be obtained for the post-adjustment level L2b of the indirect sound.

$$[ Math . 12 ]$$

$$\begin{matrix}E 2 a \times L 2 b / L 2 a = Ea / ( 1 + Rb ) \\ L 2 b = L 2 a \times Ea / ( 1 + Rb ) / E 2 a\end{matrix} \qquad ( 12 )$$

As described above, when the ratio of the direct sound and the indirect sound is adjusted, the level control unit 157 changes each of “the level of the direct sound” and “the level of the indirect sound” according to the post-adjustment ratio Rb of the direct sound and the indirect sound. That is, the post-adjustment level L1b of the direct sound and the post-adjustment level L2b of the indirect sound may be updated on the basis of above-described equation (10) and equation (12).

According to the above processing, by using one of the “absolute sound volume” and “the ratio of the direct sound and the indirect sound” as the adjustment item of the impulse response, it is possible to make it easy for a player to subjectively grasp how an adjustment operation has been reflected in an adjustment result. Furthermore, by reducing the number of adjustment items such as “the level of the direct sound” and “the level of the indirect sound” that a player has difficulty in subjectively understanding, it is possible to suppress adjustment work from becoming complicated. As a result, it is possible to make the impulse response adjustment work efficient.

### 4. Application Example

Hereinafter, another application example of adjustment of an impulse response according to the present disclosure will be described.

### (Application of Sound Component of Impulse Response to Other Classifications)

The example where the impulse response is classified into the “direct sound” and the “indirect sound” and adjusted has been described above. The technique according to the present disclosure is not limited to this, and can finely adjust an impulse response classified into an arbitrary “first sound component” and “second sound component”.

For example, an impulse response may be classified into “the direct sound+the early reflection sound” and the “late reverberation sound” to finely adjust the impulse response. Furthermore, an impulse response may be a reflection sound from a specific direction and a reflection sound from a direction other than the specific direction such as “a reflection sound from a front” and “a reflection sound from a direction other than the front” to finely adjust the impulse response. These classifications may be arbitrarily set by the user, or may be automatically set by being associated with environment information indicating a performance environment or the like in which the impulse response stored in the impulse response holding unit 152 has been measured.

### (Application to Other Usage)

The technique according to the present disclosure is not limited to the remote ensemble system, and can be applied to usage for the purpose of making adjustment of all impulse responses indicating transfer characteristics from a sound source to the both ears of the user efficient. The technique according to the present disclosure is applicable to, for example, usages exemplified below.

### (1) Mixing/Mastering Work of Stereophonic Sound

As for mixing/mastering work of a stereophonic sound, a case may be conceived that an impulse response is adjusted for the purpose of optimizing a sound field effect. In this case, an entire sound volume (absolute sound volume) influences an “equal loudness contour” that connects sound pressure levels at which expansion of a sound is felt or tones are felt equal, and therefore needs to be kept constantly during work.

Conventionally, when levels of a direct sound, an early reflection sound, a late reverberation sound, and the like of an impulse response are adjusted, the entire sound volume also changes, and therefore it has been necessary to readjust the absolute sound volume after adjustment.

By contrast with this, by applying the technique according to the present disclosure, it is possible to make readjustment of the absolute sound volume unnecessary even when, for example, a ratio of “the direct sound+the early reflection sound” and the “late reverberation sound” is adjusted, and it is possible to make mixing/mastering work of a stereophonic sound efficient.

### (2) User's Adjustment Work of Game Sound Effect

For the game sound effect, a case is assumed where sound fields such as directions of a direct sound, an indirect sound, and a reflection sound are finely adjusted according to a user's preference. In this case, when these sound fields are adjusted, an entire sound volume also changes, and therefore it has been necessary to readjust an absolute sound volume after adjustment.

By contrast with this, by applying the technique according to the present disclosure, it is possible to make readjustment of the absolute sound volume unnecessary even when, for example, a ratio of the “direct sound” and the “indirect sound” is adjusted, and make adjustment work of a game sound effect efficient and simplify a UI.

Note that the technique according to the present disclosure is applicable to usages such as live concerts, lessons, and conferences in virtual spaces in addition to the above, and applicable usages are not limited to these.

### 5. Configuration Example of Computer

The above-described series of processing can be executed by hardware or can be executed by software. When executing the series of processing by software, a program that configures the software is installed to either a computer incorporated in dedicated hardware or a general-purpose personal computer from a program recording medium.

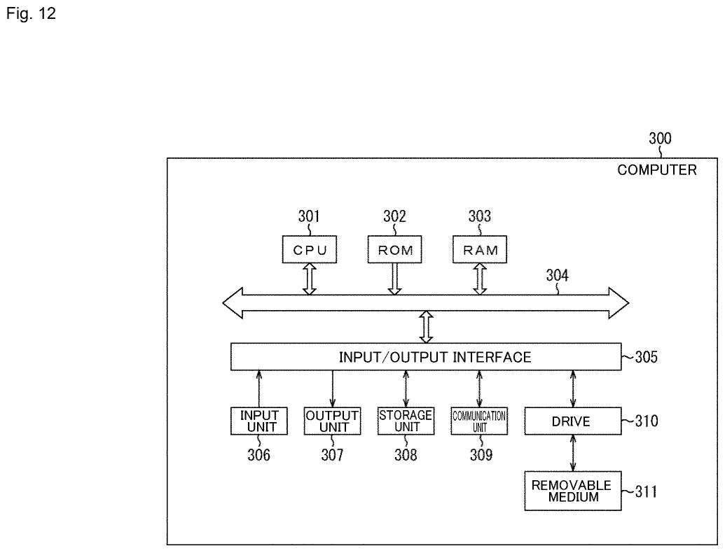

FIG. 12 is a block diagram illustrating a configuration example of hardware of a computer that executes the series of processing described above by a program. The information processing device 130 is configured by, for example, a PC having the same configuration as the configuration illustrated in FIG. 12.

A CPU 301, a Read Only Memory (ROM) 302, and a Random Access Memory (RAM) 303 are connected to one another via a bus 304.

The bus 304 is further connected with an input/output interface 305. The input/output interface 305 is connected with an input unit 306 including a keyboard, a mouse, or the like, and an output unit 307 including a display, a speaker, or the like. Furthermore, the input/output interface 305 is connected with a storage unit 308 including a hard disk, a non-volatile memory, or the like, a communication unit 309 including a network interface or the like, and a drive 310 that drives a removable medium 311.

In the computer configured as described above, for example, the CPU 301 performs the above-described series of processing by, for example, loading a program stored in the storage unit 308 to the RAM 303 via the input/output interface 305 and the bus 304 and executing the program.

For example, the program executed by the CPU 301 is recorded on the removable medium 311 or provided via a wired or wireless transfer medium such as a local area network, the Internet, or a digital broadcast to be installed in the storage unit 308.

The program executed by the computer may be a program that performs a plurality of processing in time series in the order described herein or may be a program that performs processing in parallel or at a necessary timing such as when invoked.

Meanwhile, as used herein, a system means a collection of a plurality of components (such as devices, modules (components), or the like), and all the components may be located or not located in the same housing. Thus, both of a plurality of devices stored in separate housings and connected via a network, and a single device including a plurality of modules housed in a single housing are systems.

The advantageous effects described herein are merely examples and are not intended as limiting, and other advantageous effects may be acquired.

Embodiments of the present disclosure are not limited to the above-described embodiments, and various modifications can be made without departing from the spirit of the present disclosure.

For example, the embodiments of the present disclosure employ a configuration of cloud computing where a plurality of devices share and cooperatively process one function over a network.

Furthermore, each step described in the above flowchart can be executed by a single device or executed in a shared manner by a plurality of devices.

Furthermore, when one step includes a plurality of processing, the plurality of processing included in this one step can be executed by a single device, or executed in a distributed manner by a plurality of devices.

The advantageous effects described herein are merely exemplary and are not limited, and other advantageous effects may be obtained.

Furthermore, the technology according to the present disclosure can be configured as follows.

(1)

An information processing device includes a level control unit that changes a level of a first sound component and a level of a second sound component in response to adjustment of a parameter correlated with the first sound component and the second sound component included in an impulse response.

(2)

In the information processing device described in (1), the impulse response is measured or calculated in advance.

(3)

In the information processing device described in (1), the level control unit changes the level of the first sound component and the level of the second sound component based on a relational expression expressing each of the level of the first sound component and the level of the second sound component using the parameter.

(4)

In the information processing device described in any one of (1) to (3), the parameter is an absolute sound volume.

(5)

In the information processing device described in (4), the level control unit changes the level of the first sound component and the level of the second sound component according to an adjusted change rate of the absolute sound volume.

(6)

In the information processing device described in any one of (1) to (3), the parameter is a ratio of the first sound component and the second sound component.

(7)

In the information processing device described in (6), the level control unit changes the level of the first sound component and the level of the second sound component without changing a sum of energy of the first sound component and energy of the second sound component before and after adjustment of the ratio.

(8)

In the information processing device described in any one of (1) to (7), the first sound component includes a direct sound, and the second sound component includes an indirect sound.

(9)

In the information processing device described in (8), the indirect sound includes an initial reflection sound or a late reverberation sound.

(10)

In the information processing device described in any one of (1) to (7), the first sound component includes a direct sound and an early reflection sound, and the second sound component includes a late reverberation sound.

(11)

In the information processing device described in any one of (1) to (7), the first sound component includes a reflection sound from a specific direction, and the second sound component includes a reflection sound from other than the specific direction.

(12)

The information processing device described in any one of (1) to (11) further includes a UI control unit that controls presentation of a User Interface (UI) that indicates a value of the parameter and accepts the adjustment of the parameter.

(13)

In the information processing device described in (12),
the UI further includes an indicator that indicates values of the level of the first sound component and the level of the second sound component that change in response to the adjustment of the parameter, and
the indicator does not accept adjustment of the level of the first sound component and the level of the second sound component.
   (14)

In the information processing device described in (12), the level control unit acquires at least one of the parameter adjusted by the UI, the level of the first sound component, and the level of the second sound component via the UI control unit.

(15)

In the information processing device described in any one of (1) to (14), the impulse response indicates transfer characteristics from a sound source to both ears of a user.

(16)

The information processing device described in (15) includes an output control unit that causes an output device used by the user to output a playback sound that is based on processing of convoluting of the impulse response for which the level of the first sound component and the level of the second sound component have been adjusted for an acoustic signal from the sound source.

(17)

An information processing method includes, at an information processing device, changing a level of a first sound component and a level of a second sound component in response to adjustment of a parameter correlated with the first sound component and the second sound component included in an impulse response.

(18)

A program causes a computer to execute processing of changing a level of a first sound component and a level of a second sound component in response to adjustment of a parameter correlated with the first sound component and the second sound component included in an impulse response.

### REFERENCE SIGNS LIST

1 Remote ensemble system
10 Transmission control device
110 Headphone
120 Microphone
130 Information processing device
151 Acoustic signal acquisition unit
152 Impulse response holding unit
153 Convolution processing unit
154 Output control unit
155 UI control unit
156 UI presentation unit
157 Level control unit

1. An information processing device comprising a level control unit that changes a level of a first sound component and a level of a second sound component in response to adjustment of a parameter correlated with the first sound component and the second sound component included in an impulse response.

2. The information processing device according to claim 1, wherein the impulse response is measured or calculated in advance.

3. The information processing device according to claim 1, wherein the level control unit changes the level of the first sound component and the level of the second sound component based on a relational expression expressing each of the level of the first sound component and the level of the second sound component using the parameter.

4. The information processing device according to claim 1, wherein the parameter is an absolute sound volume.

5. The information processing device according to claim 4, wherein the level control unit changes the level of the first sound component and the level of the second sound component according to an adjusted change rate of the absolute sound volume.

6. The information processing device according to claim 1, wherein the parameter is a ratio of the first sound component and the second sound component.

7. The information processing device according to claim 6, wherein the level control unit changes the level of the first sound component and the level of the second sound component without changing a sum of energy of the first sound component and energy of the second sound component before and after adjustment of the ratio.

8. The information processing device according to claim 1, wherein
the first sound component includes a direct sound, and
the second sound component includes an indirect sound.

9. The information processing device according to claim 8, wherein the indirect sound includes an early reflection sound or a late reverberation sound.

10. The information processing device according to claim 1, wherein
the first sound component includes a direct sound and an early reflection sound, and
the second sound component includes a late reverberation sound.

11. The information processing device according to claim 1, wherein
the first sound component includes a reflection sound from a specific direction, and the second sound component includes a reflection sound from other than the specific direction.

12. The information processing device according to claim 1, further comprising a UI control unit that controls presentation of a User Interface (UI) that indicates a value of the parameter and accepts the adjustment of the parameter.

13. The information processing device according to claim 12, wherein
the UI further includes an indicator that indicates values of the level of the first sound component and the level of the second sound component that change in response to the adjustment of the parameter, and
the indicator does not accept adjustment of the level of the first sound component and the level of the second sound component.

14. The information processing device according to claim 12, wherein the level control unit acquires at least one of the parameter adjusted by the UI, the level of the first sound component, and the level of the second sound component via the UI control unit.

15. The information processing device according to claim 1, wherein the impulse response indicates transfer characteristics from a sound source to both ears of a user.

16. The information processing device according to claim 15, comprising an output control unit that causes an output device used by the user to output a playback sound that is based on processing of convoluting of the impulse response for which the level of the first sound component and the level of the second sound component have been adjusted for an acoustic signal from the sound source.

17. An information processing method comprising, at an information processing device, changing a level of a first sound component and a level of a second sound component in response to adjustment of a parameter correlated with the first sound component and the second sound component included in an impulse response.

18. A program causing a computer to execute processing of changing a level of a first sound component and a level of a second sound component in response to adjustment of a parameter correlated with the first sound component and the second sound component included in an impulse response.
